(19) United States
(12) Patent Application Publication
(10) Pub. No.: US 2010/0106613 A1
(43) Pub. Date: Apr. 29, 2010

(54) Bidding System for Guaranteed Advertising Contracts in an Online Spot Market

(76) Inventors: Tarun Bhatia, Simi Valley, CA (US); Subash Sundaresan, Fremont, CA (US); Jayavel Shanmugasundaram, Santa Clara, CA (US); George Goldenberg, Los Altos, CA (US); Arpita Ghosh, Santa Clara, CA (US); Chi-Chao Chang, Santa Clara, CA (US); Shubhasheesh Anand, Mountain View, CA (US)

Correspondence Address: Stattler-Suh PC, 60 SOUTH MARKET, SUITE 480, SAN JOSE, CA, 95113, US

(21) Appl. No.: 12/258,312

(22) Filed: Oct. 24, 2008

(51) Int. Cl. G06Q 30/00; G06Q 50/00

(52) U.S. Cl. 705/26

(57) ABSTRACT

This patent discloses a system to host a competition for an online advertisement opportunity. Notice of the online advertisement opportunity may be sent to software agents, one of which may represent a guaranteed contract. On receipt of the notice, the software agents may prepare and submit bids. An ad server may receive bids, including a first bid from a first software agent representing a guaranteed contract and a second bid from a second software agent representing a nonguaranteed contract. The ad server may screen out bids and arbitrate the remaining bids to determine a highest bidder for the online advertisement opportunity.

### BACKGROUND

1. Field

The information disclosed in this patent relates to a system where bids from guaranteed advertising contracts and bids from nonguaranteed advertising contracts compete with one another to obtain an advertising opportunity in an online spot market.

2. Background Information

The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Unlike print and television advertisement that primarily seeks to reach a target audience, Internet advertising seeks to reach target individuals. The individuals need not be in a particular geographic location and Internet advertisers may elicit responses and receive instant responses from individuals. As a result, Internet advertising is a much more cost effective channel in which to advertise.

There are varieties of opportunities to advertise on the Internet, but only one advertisement may fill each opportunity. When a user sends a request to a web server to retrieve a web page, that web server may obtain one advertisement from an ad server for display to that user on the web page. The single appearance of an advertisement on a webpage may be known as an online advertisement impression. Often, there may be significant competition among advertisers to be the one to provide that advertisement impression to the user.

To participate in this competition, some advertisers contract in advance with a company (or publisher) to receive a guaranteed amount of impressions over a desired period at a pre-determined price. A buyer may further specify desired targeting criteria. For example, an advertiser and the company may agree to post 2,000,000 impressions over thirty days for US$15,000. Others merely enter into non-guaranteed contracts with the company and only pay for those impressions actually made by the company on their behalf.

Typically, available advertising opportunities first are allocated to guaranteed contracts. Once all the guaranteed contracts are filled, then those without guaranteed contracts may seek to have their advertisement shown in any remainder advertising opportunities. What is needed is a system that works towards optimizing the allocation of online advertising opportunities to the benefit of publishers and others.

### SUMMARY

This patent discloses a system to host a competition for an online advertisement opportunity. Notice of the online advertisement opportunity may be sent to software agents, one of which may represent a guaranteed contract. On receipt of the notice, the software agents may prepare and submit bids. An ad server may receive bids, including a first bid from a first software agent representing a guaranteed contract and a second bid from a second software agent representing a nonguaranteed contract. The ad server may screen out bids and arbitrate the remaining bids to determine a highest bidder for the online advertisement opportunity.

### BRIEF DESCRIPTION OF THE FIGURES

FIG. 1 is a block diagram illustrating a system 100.

FIG. 2 is a block diagram illustrating an arrangement 200 of online advertising pricing agreements 202.

FIG. 3 is a block diagram illustrating participation of ad server 114 in system 100.

FIG. 4 is a method 400 to display online advertisement 102 to user 10.

FIG. 5 is a block diagram illustrating a network 500.

FIG. 6 is a method 600 to host a multi-stage competition for an online advertisement opportunity 102 in network 500.

FIG. 7 illustrates a network environment 700 for operation of system 100.

### DETAILED DESCRIPTION

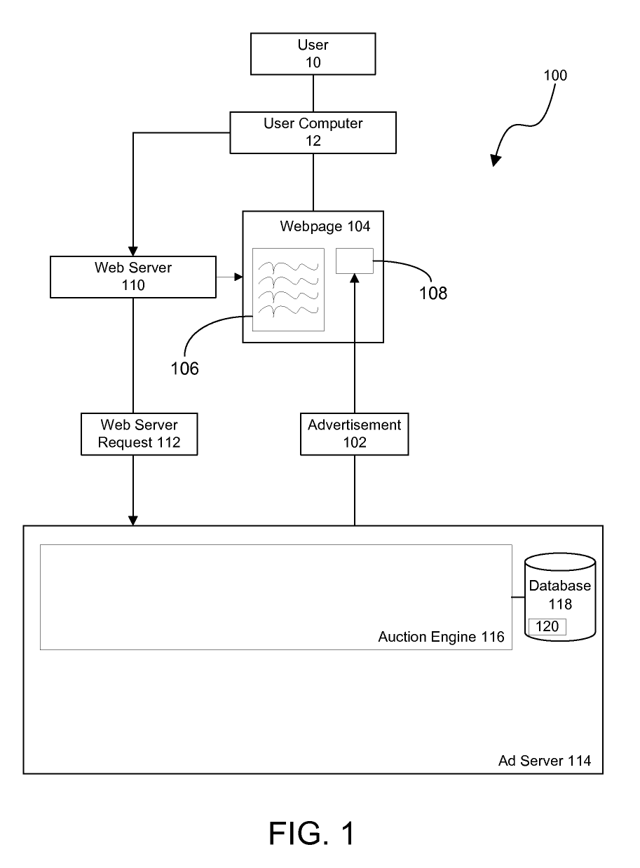

FIG. 1 is a block diagram illustrating a system 100. System 100 may be a group of independent but interrelated elements that may work to place an advertisement 102 on a webpage 104 for viewing by a user 10. A request to place advertisement 102 on webpage 104 may be thought of as an online advertisement opportunity. The decision to place a particular advertisement 102 on webpage 104 may be a result of a competition between various entities for that online advertisement opportunity.

The competition of system 100 may be a competitive auction between at least two bids received from software agents. The first bid may be from a first software agent representing at least a guaranteed contract. The second bid may be from a second software agent representing at least one of a nonguaranteed contract and a guaranteed contract. Here, at least one bid will be from a software agent representing a guaranteed contract. At the end of the auction, the online advertisement opportunity may be awarded to the highest bidder.

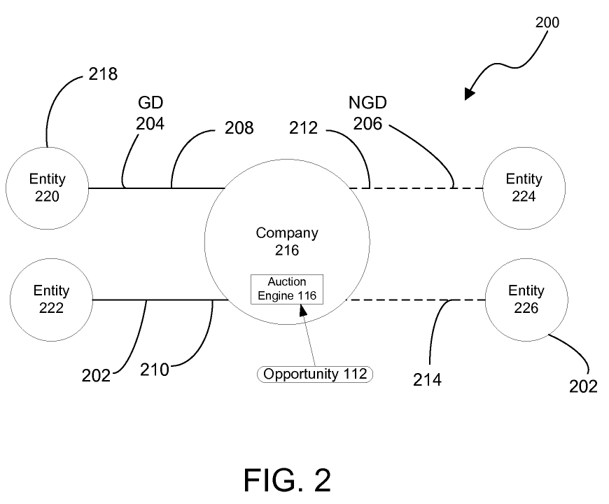

FIG. 2 is a block diagram illustrating an arrangement 200 of online advertising pricing agreements 202. Online advertising pricing agreements 202 may be divided into guaranteed contracts 204 (represented as solid lines) and nonguaranteed contracts 206 (represented as dashed lines). In this example, arrangement 200 may include a guaranteed contract 208, a guaranteed contract 210, a nonguaranteed contract 212, and a nonguaranteed contract 214. In FIG. 2, the solid lines may represent a guaranteed contract relationship between two entities and the dashed lines may represent a nonguaranteed contract relationship between two entities. In addition, GD may refer to Guaranteed Delivery contracts and NGD may refer to NonGuaranteed Delivery contracts.

Arrangement 200 may include entities 218, such as entity 220, entity 222, entity 224, and entity 226, each of whom may have binding agreements with a company 216. In an example, company 216 may mean a generic company or a generic entity, which may include a commercial or industrial enterprise and the people who constitute it. Each of the four contracts may represent an obligation of company 216 to match advertisements from entities 218 to opportunities. For example, guaranteed contract 208 may obligate company 216 to match advertisements from entity 220 to opportunities on a guaranteed quantity/time basis. Nonguaranteed contract 214 may obligate company 216 to match advertisements from entity 226 to opportunities should certain preconditions be met.

As an impression delivery promisor, company 216 may have a system to create an impression supply. For example, company 216 may create webpage content that attracts users 10. When user 10 requests a particular webpage belonging to company 216, that may create an impression opportunity. When the impression opportunity is generated from a system maintained by company 216, then company 216 may be thought of as a publisher.

Alternatively, company 216 may obtain impression opportunities from others. In an example, company 216 may obtain an impression opportunity by participating in an auction as a bidder. Company 216 may obtain opportunities such as by submitting non-guaranteed bids in response to auction notices or by placing guaranteed buys with other entities. When the impression opportunity is obtained by company 216 from others, then company 216 may be thought of as an advertisement agent. The source from which company 216 obtained the impression opportunity may be through of as a network. A network may sign up publishers and may use supply of publishers.

Guaranteed contracts 204 and nonguaranteed contracts 206 may be centered around an advertisement impression. A single appearance of advertisement 102 on webpage 104 may be considered an advertisement impression. Some companies 216 may transact as many as twenty billion advertisement impressions per day.

Guaranteed online advertising contracts 204 may include agreements between advertiser 218 and company 216 where company 216 guarantees to provide a certain amount of impressions to advertiser 218 over a fixed period for a fixed price. For example, an advertiser such as entity 220 and company 216 may agree to have 2,000,000 impressions posted over thirty days for US$15,000. Company 216 may benefit by earning and receiving the US$15,000 in advance of actually supplying the impressions and advertiser entity 220 may benefit from knowing that their advertisement will be displayed a guaranteed number of times for a capped cost during a time preselected by the advertiser. Large volume sellers, such as a nation wide auto dealership, may be willing to pay a premium to receive a guarantee against a future uncertainty of supply.

Nonguaranteed online advertising contracts 206 may include agreements between an advertiser 218 and company 216 where company 216 agrees to provide an impression only if one is available at the advertiser's set price and the advertiser 218 agrees to pay for the impression only after company 216 delivers it. Nonguaranteed contracts typically stipulate how much company 216 may charge the advertiser 218 and stipulate an upper amount that the advertiser 218 may be charged. Small volume sellers, such as an accountant offering accounting services in a small town, typically favor nonguaranteed contracts.

Nonguaranteed contracts 206 may take a variety of structures. For example, cost pro mil (CPM) (sometimes cost per mille) is an online advertising pricing model that may require payment of US$0.50 to US$1.00 for every one thousand impressions delivered. Cost per click (CPC) is an online advertising pricing model that may require payment of US$0.10 each time a user depresses and releases a mouse button to select an advertisement after its impression as part of webpage 104. As another example, cost per action (CPA) is an online advertising pricing model that may require payment of US$1.00 each time a user takes a certain action originating from an advertisement, such as submitting a form or making a purchase. The amounts and other agreed upon terms may vary from one contract to the next.

To account for the binding promise of guaranteed delivery in guaranteed contracts 204, system 100 of FIG. 1 may operate as follows. User 10 may engage a user computer 12 to request that a particular webpage 104 be displayed on user computer 12. Webpage 104 may be divided into topic content 106 and one or more advertising positions, including an advertising position 108.

The request for webpage 104 from user 10 may be sent to a web server 110. Web server 110 may be hosting a website that may include many webpages, including webpage 104. To fund this hosting service, web server 110 may seek out advertisements that may bring in revenue when shown to and/or clicked on by user 10.

On receiving the request from user 10, web server 110 may send its own request, here, a web server request 112, to an ad server 114. Web server request 112 may include an ad call request. The ad call request may be a request for ad server 114 to provide one advertisement to fill the current advertising position 108 on webpage 104. Web server request 112 may be viewed as an opportunity for advertisers to get their message in front of user 10.

Ad server 114 may be part of company 216. Ad server 114 may include decision logic to select an advertisement for an opportunity. For example, ad server 114 may include an auction engine 116 and a database 118 to assist in processing that opportunity. Auction engine 116 may include notice, pruning, and decision functions and database 118 may store preconfigured advertisements 120.

Webpage 104 may be a resource of information in web server 110 accessed through a web browser. A web browser is a software application that may enable user 10 to display and interact with text, images, videos, music, and other information located on webpage 104. The information may be in a HyperText Markup Language (HTML) format or Extensible Hypertext Markup Language (XHTML) format. Webpage 104 may provide navigation to other webpages through advertisement 102 and hypertext links.

Topic content 106 may be included as part of webpage 104. Topic content 106 may include anything on webpage 104 that is not advertisement position 108. For example, topic content 106 may include graphical user interfaces that allow user 10 to navigate to, from, and within webpage 104. Topic content 106 may include user-generated comments that may be part of a discussion webpage.

Advertising position 108 may be a particular portion webpage 104 designated to be occupied by advertisement 102. Advertising position 108 may be to the right of portions of topic content 106. In an example, there may be multiple advertising positions 108, one for each user-generated comment in an online discussion website. In an example, only some of the advertisement position 108 may include an advertisement from advertisements 120 and the remainder may remain empty of an advertisement. Ad server 114 may make a decision as to which advertisement positions 108 should be served an advertisement and which should remain empty.

As noted above, system 100 may include web server 110 (FIG. 1). Web server 110 may include a web server computer program to accept HTTP requests from user computer 12 and to serve an HTTP response along with optional data content to user computer 12. Web server 110 may include both a content management system and a computer that runs the web server computer program. Web server 110 may construct (X)HTML for each webpage 104 when it is requested by a user computer 12.

Web server request 112 may be a message sent to ad server 114 that requests something, such as one advertisement for display on webpage 104 in advertisement position 108. When requesting an advertisement such as those in database 118, web server request 112 may include opportunity data. Opportunity data may include information about user 10, such as the identity (e.g., name, age, gender) and geographic location of user 10, the date and location time of the webpage request from user 10, and metadata characterizing the particular webpage 104 requested. Web server request 112 also may include content on the web page.

Ad server 114 may include a computer server, such as a web server, that may store advertisements 120 used in online marketing and may deliver them to website visitors 10. In addition to updating the contents of web server 110 so that the website or webpage on which the advertisements are displayed may contain advertisement 102, ad server 114 may perform various other tasks such as counting the number of impressions/clicks for an ad campaign and report generation. Ad server 114 may include tools to track and monetize user clicks and ad impressions on third-party websites, such as those that may be hosted by web server 110. Ad server 114 may be a local ad server run by a single publisher and serve advertisements to that publisher's domains or may be a third party, remote ad server that may serve advertisements across domains that may be owned by multiple publishers.

An application service provider (ASP) may include a business that may provide computer-based services to customers over a network. Software offered using an ASP model also may be called On-demand software or software as a service (SaaS). Ad server 114 may be thought of as a serving system and be part of an exchange application service provider (ASP).

Auction engine 116 may be a functional unit that may assist in allocating advertisements to impressions incoming to ad server 114. Auction engine 116 may include software to perform substantial computations, including numerous arithmetic operations and logic operations. Auction engine 116 may include notice, pruning, and decision functions and database 118 may store preconfigured advertisements 120.

Database 118 may have a plurality of advertisements 120. The owner of ad server 114 may be partnered with a number of advertisers 202 and, as such, may hold a substantial inventory of advertisements 120 in database 118. Database 118 may be a structured collection of records. Each record may be an advertisement object 120 having a list of tags that may characterize the advertisement.

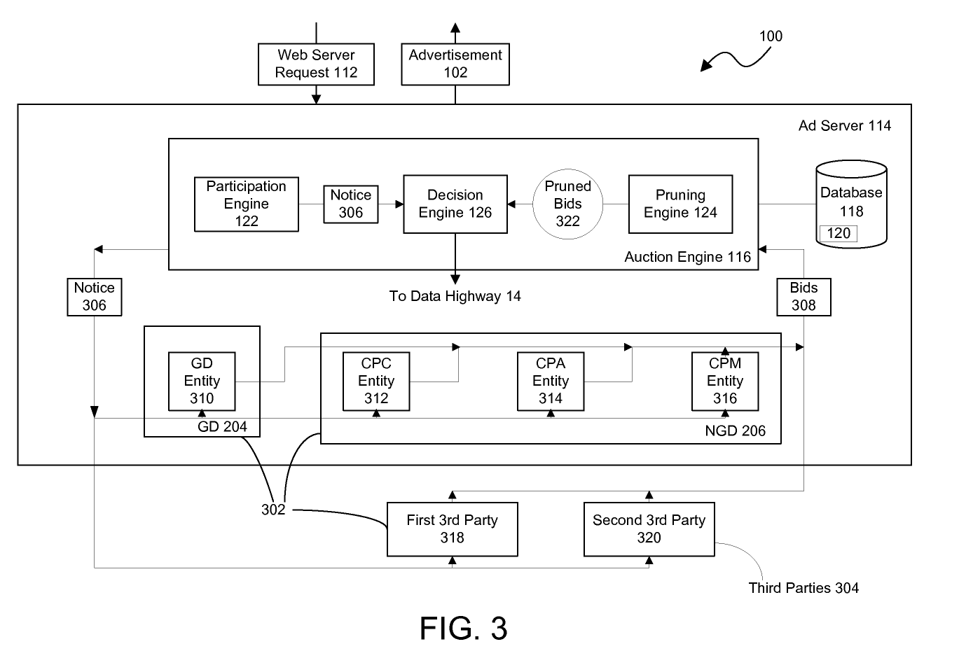

FIG. 3 is a block diagram illustrating participation of ad server 114 in system 100. When web server 112 delivers an opportunity to ad server 114, ad server 114 may conduct an auction on the spot in real time to determine which one auction participant values that opportunity the most at that point in time. System 100 may include software agents 302, such a software agent that may represent guaranteed contract 204. Here, software agents 302 may represent guaranteed contracts sold by the company currently holding the opportunity. System 100 additionally may include software agents that may represent nonguaranteed contracts 206, and software agents that may represent third parties 304. Auction engine 116 may send each software agent 302 a notice 306 about a newly available impression opportunity. On receipt of notice 306, various software agents 302 may submit bids 308 to auction engine 116 for processing. Auction engine 116 may include a participation engine 122, a pruning engine 124, a decision engine 126 to communicate and process the auction.

Bids from guaranteed contract 204 may be prescreened into one highest bid, from guaranteed delivery contract (GD) entity 310. Bids based on nonguaranteed delivery contracts 206 may be a function of the source and online advertising pricing model utilized between two entities. For example, bids based on nonguaranteed delivery contracts 206 may come from cost per click (CPC) entity 312, cost per action (CPA) entity 314, and cost per mille (CPM) entity 316. Bids from third parties 304 may be from one or more third parties, such as first third party 318 and second third party 320. At the end of the bidding, ad server 114 may send information to data highway 14 and may deliver that impression opportunity to the auction winner, who then may have their advertisement 102 delivered into advertising position 108 or redirect that impression opportunity into a new auction.

Participation engine 122 may be a device that may receive and process an opportunity to show an advertisement. Different software agents 302 may compete for that opportunity. Participation engine 122 may include software to process that received opportunity, to determine which software agents 302 may be eligible to bid for that opportunity, and to generate notice 306 for transmittal to those software agents 302 who also are eligible participants based on predetermined criteria. Eligibility criteria may include determining whether a software agent 302 is in communication with auction engine 116. Auction engine 116 may translate to matching engines 302 the opportunity and who is eligible to participate for that opportunity.

Pruning engine 124 may be a device to receive and process bids 308 into a set of pruned bids 322. Pruning engine 124 may be a global pruning engine that reviews each bid 308 for eligibility. Pruning engine 124 may perform a variety of screens. For example, pruning engine 124 may perform a budget check to ensure available funds or to ensure that the bid does not exceed the budget for its associated campaign. As another example, pruning engine 124 may perform a self-competition check to remove any duplicated bids from a particular software agent 302 and duplicate bids for the same company such as those coming from multiple software agents in the network.

Decision engine 126 may be a device that may receive pruned bids 322 and utilize software to arbitrate between the bids. Decision engine 126 may function to auction, display, and record. The arbitration auction may be across numerous advertising campaigns and software agents 302 that may represent such campaigns. The arbitration auction may determine which software agent 302 places a highest value on the immediate impression opportunity. A goal of the auction may be to obtain the most revenue for the publisher that created the impression opportunity, here web server 110 (FIG. 1). The revenue may be shared between web server 110 and the host of the auction, here company 216.

In an example, the online auction may be a blind auction where software agents 302 may submit one bid and a winner may be declared after one round of bidding. In another example, the online auction may include, but not be limited to a candle auction, a Chinese auction, combinatorial auction, a Dutch auction, an English auction, a reverse auction, a sealed first-price auction, a silent auction, a uniform price auction, a Vickrey auction, and a Walrasian auction. Once the auction is complete, decision engine 126 may display advertisement 102 in advertisement position 108 (FIG. 1) as a winning advertisement and send information about the completed auction to data highway 14 for recordation and other purposes. The recorded auction information may be a log of the event happenings for use in billing, impression delivery counting, and statistics. Data highway 14 may be a pathway for data, such as may be connected to database 118 and other data recipient devices.

Software agents 302 may be computer representatives who may act on behalf of the terms of an online advertising contract. Software agent 302 may include a matching engine to match an opportunity to the contract and advertising campaign represented by software agent 302. Underlying each contract may be a demand campaign and a matching engine may assist software agent 302 in determining which campaign and which advertisement to match to that incoming opportunity. Guaranteed contract entity 310, CPC entity 312, CPA entity 314, CPM entity 316, first third party 318, and second third party 320 each may be a software agent 302.

Third parties 304, including first third party 318 and second third party 320, may be legal entities distinct from that operating ad server 114. Third parties 304 may maintain their own separate system and may not be part of an advertising technology platform hosted by ad server 114. Typically, they may utilize a technology base that may be different from the technology base utilized by ad server 114. Rather than being part of an advertising technology platform hosted by ad server 114, third parties 304 may maintain their own separate ad serving system and plug-into ad server 114 through interfaces. For example, New York based company DoubleClick® presently may be considered a third party 304 that may be invited to auctions held through ad server 114. When in communication with ad server 114, third parties 304 may be informed of each new impression opportunity and compete for that impression opportunity with guaranteed contracts 204 and nonguaranteed contracts 206.

Third parties 304 may play an important role in the overall ecosystem of system 100. Third parties 304 may bring with them increased competition for a single impression opportunity presented to ad server 114. The increased competition may make the overall bidding process more efficient since, for example, the winning bid may be closer to the theoretical maximum winning bid.

Notice 306 may be an announcement containing information about an impression opportunity. Notice 306 may include a description of the opportunity and who is eligible to participate for that opportunity. Notice 306 may include tags to restrict who receives notice 306 to those that may be eligible to bid for the opportunity.

Bids 308 may be formal proposals from software agents 302 to buy the impression opportunity mentioned in notice 306 at a specified price. Each bid may carry with it an advertisement proposed to be matched with the impression opportunity. Some bids 308 may contain instructions to utilize an advertisement 120 residing in database 118. Some bids 308 may merely seek to purchase the opportunity to make the impression without a desire to insert an advertisement into that impression. The opportunity itself may have value and bring profit to the holder at a subsequent auction. Under such circumstances, some bids 308 may not include an advertisement.

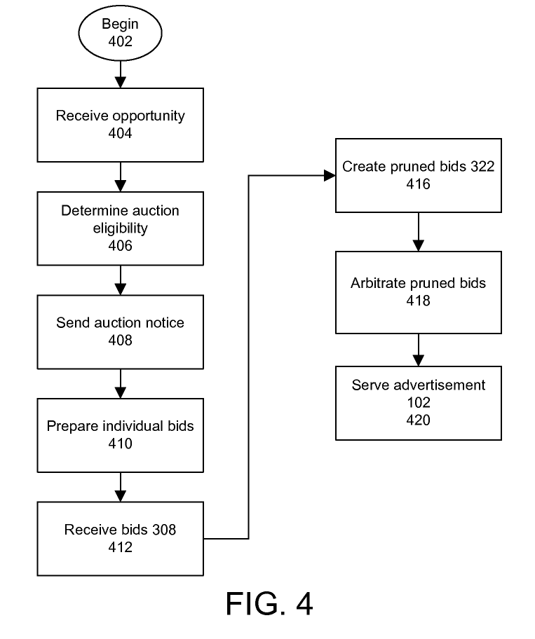

FIG. 4 is a method 400 to display online advertisement 102 to user 10. Method 400 may begin at step 402. At step 404, method 400 may receive online advertisement opportunity 112. Opportunity 112 may be received by auction engine 116 in ad server 114. Opportunity 112 may be an impression opportunity or some other advertisement opportunity.

At step 406, method 400 may determine which entity represented by software agents 302 may be eligible to bid for opportunity 112. At step 408, method 400 may send out notice 306. Notice 306 may be sent to decision engine 126 and to each software agent 302 representing an eligible entity. At step 410, software agents 302 may prepare individual bids. Software agents 302 representing guaranteed contracts 204 sold by the current owner of the opportunity may be eligible and may prepare bids that may compete against bids from software agents representing nonguaranteed contracts 206 and those representing third parties 304. At step 412, auction engine 116 may receive bids 308.

At step 412, method 400 may screen out some bids within bids 308 to create pruned bids 322. At step 418, method 400 may arbitrate among pruned bids 322. At step 420, method 400 may serve winning advertisement 102 into advertisement position 108. Alternate actions at step 420 may include delivering the opportunity to another entity whose nonguaranteed bid wins the auction, or gets allocated the opportunity after a guaranteed bid wins.

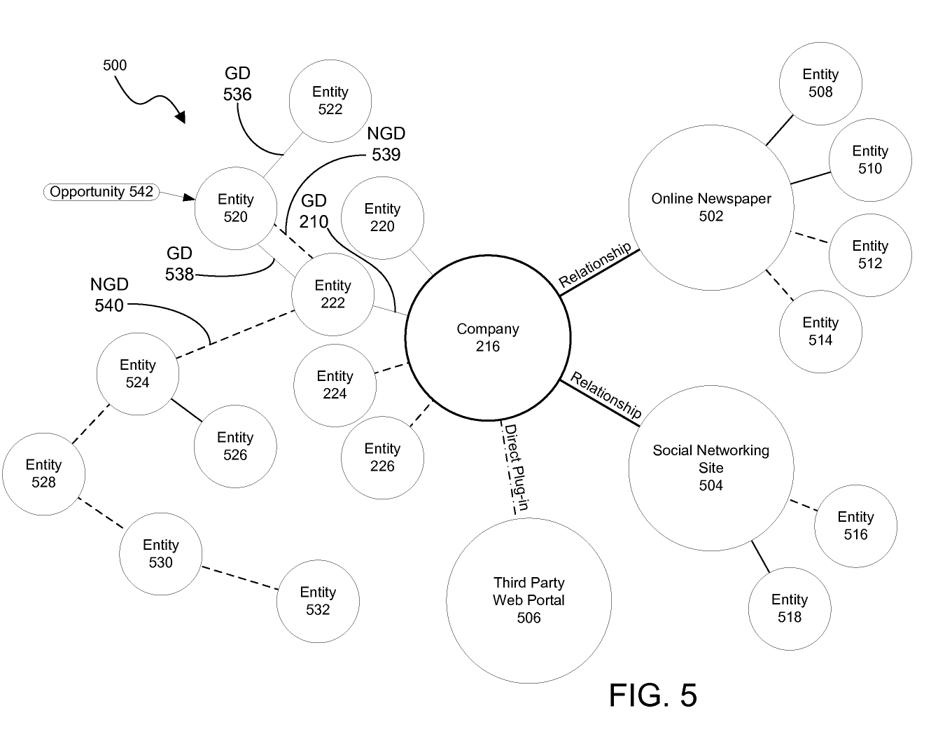

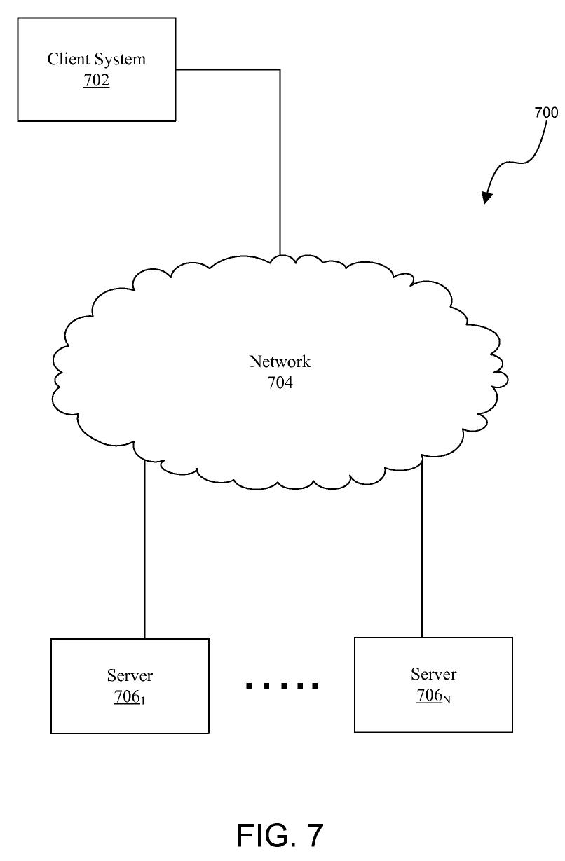

FIG. 5 is a block diagram illustrating a network 500. Network 500 may be a group of independent but interrelated elements that may work to place an advertisement 102 on a webpage 104 for viewing by a user 10. The decision to place the particular advertisement 102 on webpage 104 may be a result of a competitive auction among software agents 302, each of whom may represent different online advertising pricing agreements. Network 500 may utilize system 100 and extend the competitive auction across the Internet 704 (FIG. 7) through various entities having any number of advertising relationships. In effect, network 500 may represent a network of networks arranged to come together at impression opportunity exchange 114 to maximize a value of any one impression opportunity 112 through a participation of many bids for that impression opportunity.

Network 500 may represent a multi-stage auction with transfer of opportunity ownership, in certain use cases. Transfer of ownership may be a key factor in network 500. Here, the right to serve an impression may be acquired in a first auction and then immediately be put up for sale in a second auction. Once that right is acquired in the second auction, the right may be put up for sale in a third auction. Network 500 does not restrict the number of auctions (n-auctions) that may occur for a single impression opportunity. An auction for the opportunity may occur where there is a seller willing to sell and a buyer willing to buy. Each owner of the right to serve an impression may use that opportunity or put that right up for sale at an auction.

Under network 500, an auction need not be hosted by company 216. An auction may be hosted by any entity utilizing software implementing methods of system 100 and network 500. Assuming an engine may respond to ad server 114 through a system interface, with a guaranteed bid in response to each opportunity, the exchange auction may arbitrate to maximize revenue for publisher 110 as in system 100. If GD entity 310 wins, the opportunity will be awarded to guaranteed demand pool 204 it may represent. Guaranteed demand pool 204 subsequently may allocate that opportunity towards fulfilling one of several guaranteed delivery obligations that may be outstanding at the time.

In the exchange of network 500, guaranteed contracts 204 may be bought and sold, sometimes by the same network. An opportunity may go through a chain of guaranteed contracts before it is assigned a creative 102. Each link in this chain may correspond to a transfer of ownership, with each owner potentially holding another auction to maximize its payout. Here, a multi-stage auction may be employed at each link in such a chain. Guaranteed contract relationships in a linked network model may be supported with a unified marketplace model. Network 500 may enable unification of guaranteed and nonguaranteed marketplaces, which maximizes publisher revenue.

When a guaranteed contract is added to a network, the value that guaranteed contract places on an opportunity changes over time and the buyer of the guaranteed contract may have obligations of its own downstream. Guaranteed contracts may be to show a certain number of impressions between advertiser and seller, or to deliver a certain number of opportunities between seller and another buyer. An auction may result in a transfer of ownership of the right to make serve an impression when a guaranteed contract is involved in the bidding process.

Network 500 may include company 216, an online newspaper 502, a social network site 504, a third party web portal 506, and a variety of entities having guaranteed contracts and nonguaranteed contracts relationships. Online newspaper 502 may service an entity 508 through a guaranteed contract, an entity 510 through a guaranteed contract, an entity 512 through a nonguaranteed contract, and an entity 514 through a nonguaranteed contract. Social network site 504 may service an entity 516 through a nonguaranteed contract and an entity 518 through a guaranteed contract. Third party web portal 506 may have a direct plug-in into company 216 to receive notices 306 of opportunities 112 for which third party web portal 506 may be eligible.

Network 500 additionally may include an entity 520. Entity 520 may have a guaranteed contract obligation 536 to service the impression needs of entity 522. Additionally, entity 520 may have a guaranteed contract obligation 538 to service the impression needs of entity 222. For example, guaranteed contract 538 may obligate entity 520 to deliver 100,000 impression opportunities to entity 222 over a thirty-day period.

Guaranteed delivery contract 210 may establish a relationship between entity 222 and company 216. In general, their established relationship may benefit entity 522 by being able to sell company 216 opportunities for a profit during a period when company 216 is obligated to provide opportunities to entity 222. Here, entity 222 and company 216 may benefit from their established relationship.

As part of the obligations of entity 522, entity 222 may have entered into a nonguaranteed delivery contract 540 with entity 524. In other words, entity 222 may be obligated to provide an opportunity to entity 524 if certain nonguaranteed conditions are met. In turn, entity 524 may have its own contractual relationships, such as a guaranteed contract with entity 526, who subsequently downstream may have a connected series, and a connected series of nonguaranteed contracts with entity 528, entity 530, and entity 532.

Company 216, online newspaper 502, social network site 504, and third party web portal 506 each may be advertisement agents and each may have a web site capable of creating a supply of impression opportunities. For example, company 216 may provide vertical search services within its own website for images, video, local interests, news, and shopping. This may represent thousands of webpages 104, each of which may include multiple advertising positions 108. Online newspaper 502 may have webpages 104 related to entertainment, obituaries, food, news, horoscope, and weather, each of which may include advertising positions 108. Social network site 504 and third party web portal 506 additional may maintain webpages 104 having advertising positions 108. When any one of webpages 104 is requested by user 10, that request may generate from one to ten or more impression opportunities.

Entity 522 and entity 528 may be advertisement agents who do not additionally generate impression opportunities. Their function may be to locate impression opportunities available on other websites and seek to acquire the opportunities on behalf of their clients. Since they are dedicated to seeking out impression opportunities, their participation in network 500 may bring additional efficiencies to network 500 that otherwise may be overlooked.

Online newspaper 502 and social networking site 504 may be part of an advertising technology platform controlled by ad server 114 and hosted by company 216. Here, company 216 may have preexisting contractual relationships with online newspaper 502 and social networking site 504 that allow any of the three parties to receive notice of and bid for an impression opportunity generated by any entity that is part of the advertising technology platform hosted by ad server 114. In addition to sharing impression opportunity supply inventory, each may receive technology that comes with the advertising technology platform.

Company 216, online newspaper 502, and social networking site 504 each may be running the same advertising software program whereas third party web portal 506 may be running its own advertising software program. Third party web portal 506 may connect to the advertising technology platform through a direct plug-in into company 216 or through an indirect route, such as through a connected series of guaranteed delivery contracts 520, 522, and 524. Third party web portal 506 may not have a duty to provide notices of its own impression opportunities to the advertising technology platform members, but nonetheless may receive notice of and bid for impression opportunity generated by the advertising technology platform members.

Company 216 may fill some of the impression requirements of entity 222 from impressions generated by company 216. Other impressions may come from a member of the advertising technology platform, such as social networking website 502. Noteworthy in this arrangement is that social networking website 502 is not a party to guaranteed contract 210 and yet may be contributing opportunities towards fulfilling the terms of that contract with its own inventory through network 500.

Network of entities is formed when they have connections among them. Contracts from one entity may participate in auctions for opportunities from another in the network. Direct connections to company 216 to obtain opportunities from company 216 may be considered a network. The interconnections of each of these individual networks may be considered a network 500 of networks.

Importantly, network 500 may allow company 216 to tap into the impression inventory of social networking website 502 and participate in a bidding scheme for those impressions to fill its own guaranteed and nonguaranteed online advertising delivery contracts. Company 216 additionally may participate in a bidding for an opportunity that arises elsewhere in this network of networks. The term network also may be used for an “ad network”, which may include any entity that has multiple demand or supply it matches. A network of such entities may be viewed as a network of networks.

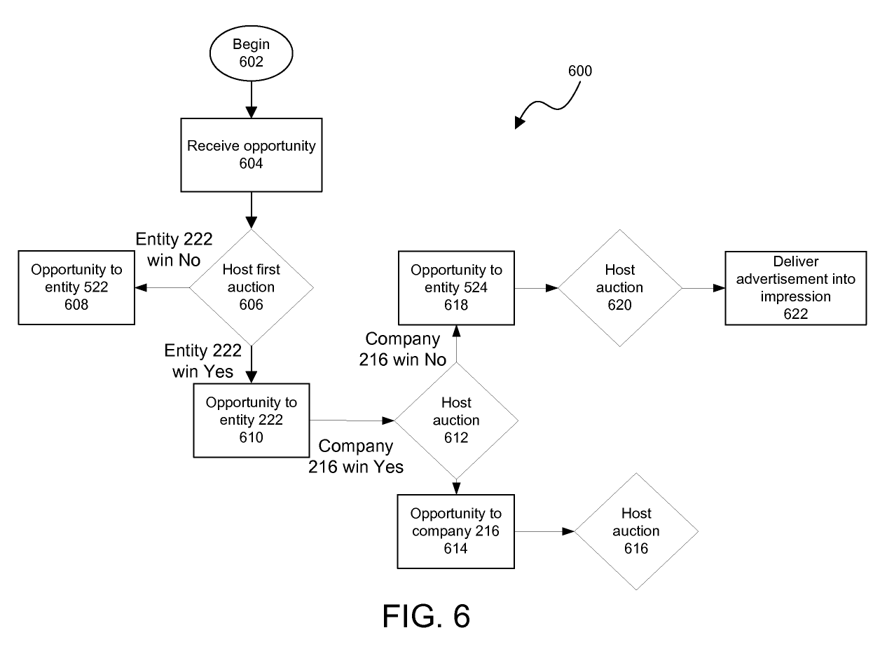

FIG. 6 is a method 600 to host a multi-stage competition for an online advertisement opportunity 102 in network 500. Method 600 may begin at step 602. At step 604, entity 520 may receive an opportunity 542. Here, user 10 may have requested webpage 104 having advertising position 108 that generated opportunity 542. Entity 520 may have created webpage 104 that generate opportunity 542 or may have received opportunity 542 through some other method, such as through an auction.

A guaranteed bid from the agent may win the opportunity, which subsequently may be allocated to one of the many guaranteed contracts it represented when bidding (based on some logic). The agent may work on behalf of the guarantor—and represents a bid considering all guarantees remaining to be fulfilled. If the buyer of the guarantee contract that gets the opportunity is an advertiser, it may get to serve the ad (the ad may be with the guarantor, or with some service). If the buyer of the guarantee contract that gets the opportunity is another entity, the opportunity may be diverted to them to use as they wish—further auction for instance.

Entity 520 immediately may satisfy its impression opportunity delivery obligation to entity 522. However, at that moment in time, 520's contract obligation to entity 222 may be more at risk than 520's obligation to entity 522, and may thus place a higher value for the opportunity. Thus, at step 606, entity 520 may host an auction. One of the software agents participating may represent all the guaranteed contracts of entity 520 in one or more bids. For example, entity 520 may enter a first bid on behalf of guaranteed contract 536 entity 520 has with entity 522. In this regard, entity 520 has received a first bid from its guaranteed bidding agent representing guaranteed contract 536. Entity 520 additionally may enter a second bid on behalf of the guaranteed contract entity 520 has with entity 222. Alternatively, entity 520 may enter a single bid to on behalf of the guaranteed contracts entity 520 has with both entity 522 and entity 222. Further, entity 222 may enter a bid based on a nonguaranteed contract 539 with entity 520. Here, entity 520 may receive this bid from a nonguaranteed bidding agent representing nonguaranteed contract 539. Entity 520 may utilize system 100, including method 400, to determine a winner between the submitted bids.

If entity 222 is the winner of the auction through its bid based on nonguaranteed contract 539, then opportunity 542 may be delivered to entity 522 at step 608. This delivery from entity 520 may not count towards satisfying guaranteed contract 538. If entity 222 is not the winner of the auction, then entity 520 may chose at step 610 to satisfy one of the guaranteed contracts entity 520 has with entity 522 and entity 222. If entity 520 wins the auction and sends the opportunity to entity 222, entity 520 then may have satisfied one unit of its opportunity obligations to entity 222 under guaranteed contract 538.

On receipt of opportunity 542, entity 222 immediately may satisfy its own impression opportunity delivery obligations or may host an auction to maximize value of opportunity 542. Because of a preexisting relationship with entity 222, this auction may include company 216. Thus, at step 612, entity 222 may host an auction. As part of the auction, entity 222 may direct its software agent to enter a first bid on behalf of the obligation entity 222 has to company 216 under guaranteed contract 210. Entity 524 may enter a second bid based on the relationship entity 524 has with entity 222 through nonguaranteed contract 540. Entity 222 then may determine a winner and deliver the obligation according to that determination.

A bid from entity 524 may be based on its nonguaranteed contracts. If the bid representing guaranteed delivery contract 210 as may be entered by a software agent of entity 222 is the highest bid in the auction, company 216 may be viewed as being the winner of the auction and opportunity 542 may be delivered to company 216 at step 614. Company 216 then may host its own auction at step 616 as set out in method 400 above. If the bid from entity 524 is the highest bid in the auction, then company 216 may not be the winner of the auction. Opportunity 542 then may be delivered to entity 524 at step 618. At step 620, entity 524 may host an auction between guaranteed contract 526 and entity 528 and determine a winner. At step 622, a winner of the auction hosted by entity 524 may serve their advertisement 102 into webpage 104.

FIG. 7 illustrates a network environment 700 for operation of system 100. The network environment 700 may include a client system 702 coupled to a network 704 (such as the Internet, an intranet, an extranet, a virtual private network, a non-TCP/IP based network, any LAN or WAN, or the like) and server systems 7061 to 706N. A server system may include a single server computer or a number of server computers. Client system 702 may be configured to communicate with any of server systems 7061 to 706N, for example, to request and receive base content and additional content (e.g., in the form of photographs).

Client system 702 may include a desktop personal computer, workstation, laptop, PDA, cell phone, any wireless application protocol (WAP) enabled device, or any other device capable of communicating directly or indirectly to a network. Client system 702 typically may run a web-browsing program that may allow a user of client system 702 to request and receive content from server systems 7061 to 706N over network 704. Client system 702 may one or more user interface devices (such as a keyboard, a mouse, a roller ball, a touch screen, a pen or the like) to interact with a graphical user interface (GUI) of the web browser on a display (e.g., monitor screen, LCD display, etc.).

In some embodiments, client system 702 and/or system servers 7061 to 706N may be configured to perform the methods described herein. The methods of some embodiments may be implemented in software or hardware configured to optimize the selection of additional content to be displayed to a user. In one example, client system 702 and/or system servers 7061 to 706N may include or be part of ad server 114.

Part or all of system 100 may be implemented as a computer program product on a storage medium having instructions stored thereon/in. These instructions may be used to control, or cause, a computer to perform any of the processes. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium, system 100 may include software both to control the hardware of a general purpose/specialized computer or microprocessor and to enable the computer or microprocessor to interact with a human consumer or other mechanism utilizing the results of system 100. Such software may include without limitation device drivers, operating systems, and user applications. Ultimately, such computer readable medium further may include software to perform system 100.

In initially entering into a guaranteed contract, an advertiser may buy and a publisher may sell the promise of the publisher to place an advertisement for a fixed amount. Once that first contract is set, the publisher then may need to buy an impression to fulfill its promise. The purchase of that impression would be a second contract, but this time between the publisher as a supply buyer and the web server impression seller.

In utilizing system 100, the publisher eventually may meet the guarantee of delivering all the impressions to an advertiser promisee, but not necessarily for a given opportunity. For a 30-day contract guaranteeing 2,000,000 impressions for $15,000, the cost per impression paid to the publisher by the advertiser is $0.0075 (=$15,000/2,000,000). If the publisher is able to turn around and buy an impression for $0.0065 in a competitive auction, that publisher will turn an additional profit of $0.0010. If the publisher was able to do the same for each of billion impressions it may make per day, that may represent an additional profit of $100,000 per day.

An ability of a publisher to turn an additional profit on a guaranteed contract may be a function of where the guaranteed contract is in the life of the contract. If the life of each guaranteed contracts were thirty days, those closer to the end of the thirty days may value a given opportunity more than those closer to the beginning of the thirty days, due to a greater uncertainty of not meeting those guarantees. Taking these and other factors into account, there may be a price at which a publisher can bid in a unified competitive auction to make an additional profit on a guaranteed contract. When a guaranteed contract is added to that a network, the value that guaranteed contract places on an opportunity changes over time and the buyer of the guaranteed contract may have obligations of its own downstream. An auction may result a transfer of ownership of the right to make an impression when a guaranteed contract is involved in the bidding process.

The information disclosed herein is provided merely to illustrate principles and should not be construed as limiting the scope of the subject matter of the terms of the claims. The written specification and figures are, accordingly, to be regarded in an illustrative rather than a restrictive sense. Moreover, the principles disclosed may be applied to achieve the advantages described herein and to achieve other advantages or to satisfy other objectives, as well.

What is claimed is:

1. A method to host a competition for an online advertisement opportunity, the method comprising:
receiving a first bid in an ad server from a first software agent representing at least a guaranteed contract; and
receiving a second bid in an ad server from a second software agent representing at least one of a nonguaranteed contract and a guaranteed contract.

2. The method of claim 1, further comprising:
determining whether a software agent representing a guaranteed contract is eligible to bid for the online advertisement opportunity.

3. The method of claim 2, further comprising:
if the software agent representing a guaranteed contract is eligible to bid for the online advertisement opportunity, then sending a notice to the software agent representing a guaranteed contract.

4. The method of claim 1, further comprising:
screening out bids to compile a set of pruned bids.

5. The method of claim 4, where screening out bids does not restrict a bid based on a promise to fulfill a guaranteed contract.

6. The method of claim 1, further comprising:
arbitrating between the first bid and the second bid.

7. A computer readable medium comprising a set of instructions which, when executed by a computer, cause the computer to host a competition for an online advertisement opportunity, the instructions for:
receiving a first bid in an ad server from a first software agent representing at least a guaranteed contract; and
receiving a second bid in an ad server from a second software agent representing at least one of a nonguaranteed contract and a guaranteed contract.

8. The computer readable medium of claim 7, further comprising:
determining whether a software agent representing a guaranteed contract is eligible to bid for the online advertisement opportunity.

9. The computer readable medium of claim 8, further comprising:
if the software agent representing a guaranteed contract is eligible to bid for the online advertisement opportunity, then sending a notice to the software agent representing a guaranteed contract.

10. The computer readable medium of claim 7, further comprising:
screening out bids to compile a set of pruned bids.

11. The computer readable medium of claim 10, where screening out bids does not restrict a bid based on a promise to fulfill a guaranteed contract.

12. The computer readable medium of claim 7, further comprising:
arbitrating between the first bid and the second bid.

13. An ad server to host a competition for an online advertisement opportunity, the ad server comprising:
an auction engine to receive a first bid from a first software agent representing at least a guaranteed contract and to receive a second bid in an ad server from a second software agent representing at least one of a nonguaranteed contract and a guaranteed contract.

14. The ad server of claim 13, further comprising:
a participation engine to determine whether a software agent representing a guaranteed contract is eligible to bid for the online advertisement opportunity.

15. The ad server of claim 14, where the participation engine is configured to compile a notice about the online advertisement opportunity for receipt by the software agent representing a guaranteed contract.

16. The ad server of claim 13, further comprising:
a pruning engine to screen out bids and to compile a set of pruned bids.

17. The ad server of claim 16, where the pruning engine includes a set of screening instructions that do not restrict a bid based on a promise to fulfill a guaranteed contract.

18. The ad server of claim 17, further comprising:
a decision to arbitrate between the first bid and the second bid.
